(19) United States
(12) Patent Application Publication
(10) Pub. No.: US 2010/0021086 A1
(43) Pub. Date: Jan. 28, 2010

(54) SYSTEM AND METHOD FOR SEARCHING FOR CONTACT

(75) Inventors: Cho-Hao WANG, Tu-Cheng (TW); Kuan-Lin WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,112

(22) Filed: Apr. 27, 2009

(30) Foreign Application Priority Data
Jul. 25, 2008 (CN) 200810303077.0

(51) Int. Cl. G06K 9/54; G06F 17/30

(52) U.S. Cl. 382/305; 707/3

(57) ABSTRACT

A system and method for searching for a contact by a handheld device includes creating a face database, the face database storing face images, and association of the face images with contact information, selecting an image from a photo stored in the handheld device, locating a face in the selected image, comparing the located face with face images stored in the face database, and determining if a matched face image is found in the face database. The method further includes listing contact information associated with the matched face image, the information comprising a phone number of the contact, creating an association between the located face and a user-selected contact if no matched face image is found, and storing the located face and the association in the face database.

### BACKGROUND

1. Technical Field

Embodiments of the present disclosure relate to call management, and particularly to a system and method for searching for a contact.

2. Description of Related Art

Currently, compact handheld devices such as mobile phones are broadly utilized by people in daily life for multiple functions.

An image browsing program is used to browse through images stored in the handheld device. However, if a user wants to call a contact corresponding to one of the images, the user must exit the image browsing program, and find the corresponding contact in a phone book of the handheld device, which is inconvenient.

### BRIEF DESCRIPTION OF THE DRAWINGS

FIG. 1 is a schematic diagram of one embodiment of a system for searching for a contact;

FIG. 2 is a block diagram of one embodiment of a search unit shown in FIG. 1;

FIG. 3 is a flowchart of one embodiment of a method for searching for a contact; and

FIG. 4a to FIG. 4d are schematic diagrams of one embodiment for showing the process of locating a face in a selected image.

### DETAILED DESCRIPTION

All of the processes described below may be embodied in, and fully automated via, functional code modules executed by one or more general purpose mobile devices or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

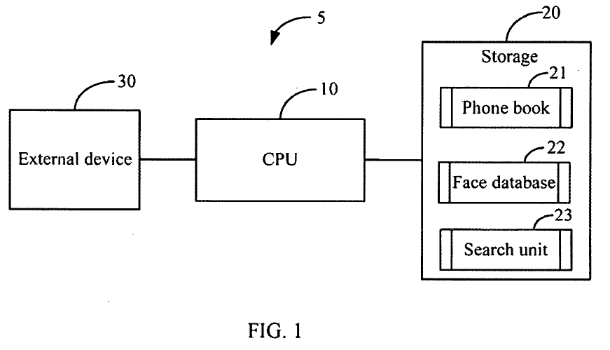

FIG. 1 is a schematic diagram of one embodiment of a system 5 for searching for a contact. Depending on the embodiment, the system 5 may be a handheld device, such as a cell phone, a digital camera, a personal digital assistant (PDA), or other electronic device. In one embodiment, the system 5 includes at least a central processing unit (CPU) 10, a storage 20, and an external device 30. The CPU 10 is connected to the storage 20 and the external device 30. In one embodiment, the storage 20 includes a phone book 21, a face database 22, and a search unit 23. The storage 20 may be a flash memory and the external device 30 may include a liquid crystal display (LCD) and a keyboard. The phone book 21 stores contact information, such as name, address, and phone numbers of contacts. The face database 22 stores face images, and associations of the face images with the contact information.

The CPU 10 controls execution of the search unit 23. The search unit 23 is used to locate a face in a selected image from a photo stored in the system 5, find a face matching the located face in the face database 22, and list the contact information associated with the matched face.

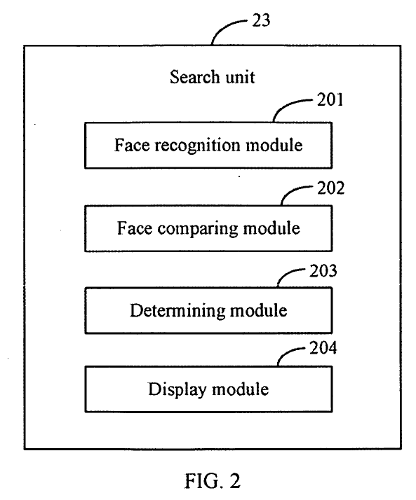

FIG. 2 is a block diagram of one embodiment of the search unit 23 shown in FIG. 1. The search unit 23 includes a face recognition module 201, a face comparing module 202, a determining module 203, and a display module 204. In one embodiment, the modules 201-204 may comprise computerized instructions that are stored in the storage 20. The CPU 10 may execute the computerized instructions to implement one or more operations of the handheld device.

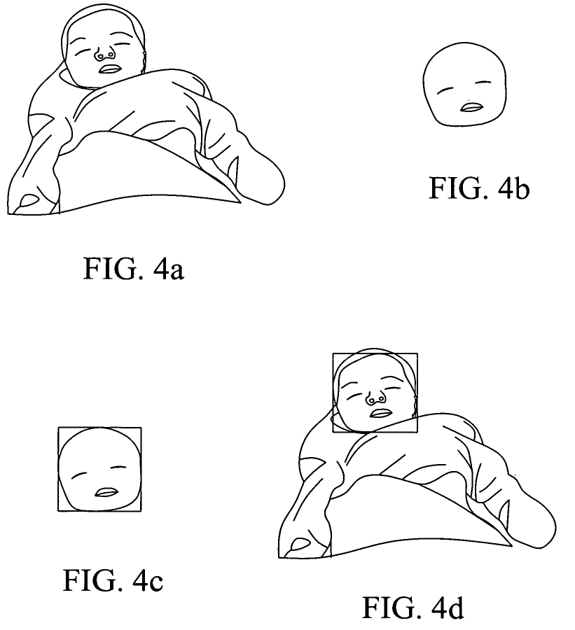

The face recognition module 201 locates a face in a selected image (referring to FIG. 4a) from a photo stored in a memory system of the handheld device. In one embodiment, the face recognition module 201 locates a face (referring to FIG. 4b) using an skin color model in YCbCr space. In YCbCr, the Y is the brightness (luma), Cb is blue minus luma (B-Y), and Cr is red minus luma (R-Y). One example of an equation for finding facial skin is as follows.

$$P ( x , y ) = \{ \begin{matrix}1 , & if [ 135 \leq Cr ( x , y ) \leq 156 ] ⋂ [ 108 \leq Cb ( x , y ) \leq 123 ] \\ 0 & otherwise\end{matrix}$$

In the equation, “P” stands for a pixel in the image, and “(x, y)” stands for a coordinate of “P”. In one embodiment, a value of Cr(x, y) ranges from 135 to 156, a value of Cb(x, y) ranges from 108 to 123. In other embodiments, the values of the Cr(x, y) and the Cb(x, y) may be any other suitable ranges. If a value of the P(x, y) is 1, the face recognition module 201 judges that an examined area in the image is facial skin. If a value of the P(x, y) is 0, the face recognition module 201 judges that an examined area in the image is not facial skin. If the examined area is facial skin, then the examined area in the image is set to white, otherwise, the examined area is set to black. Then, the face recognition module 201 calculates a smallest rectangle framing the face to locate the face in the image (referring to FIG. 4c and FIG. 4d).

The face comparing module 202 compares the located face with the face images stored in the face database 22. In one embodiment, the face comparing module 202 compares the located face with the face images stored in the face database 22 by calculating a similarity between the located face and each face image stored in the face database 22.

The determining module 203 determines if a matched face image is found in the face database 22. In one embodiment, the determining module 203 determines a face image in the face database 22 matches the located face if the similarity between the located face and the face image is greater than or equal to a preset value.

The display module 204 lists contact information associated with the matched face image if the matched face image is found in the face database 22.

The face comparing module 202 creates an association between the located face and a user-selected contact if no matched face image is found in the face database 22, and stores the located face and the association in the face database 22.

In other embodiment, the face recognition module 201 locates all faces in the selected image if the selected image includes more than one face, and the face comparing module 202 compares each located face with the face images stored in the face database 22.

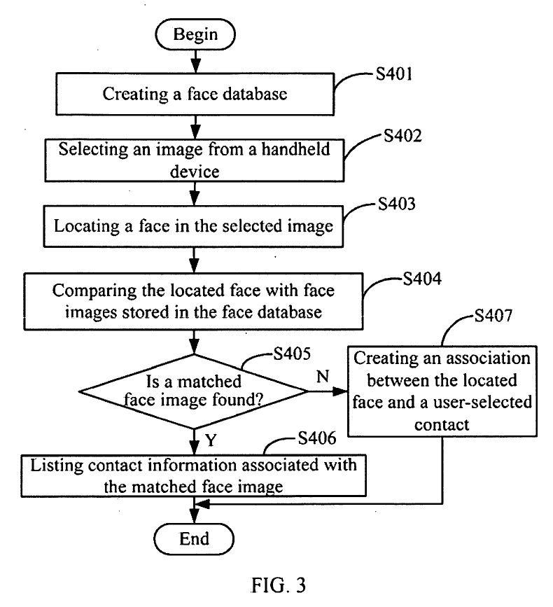

FIG. 3 is a flowchart of one embodiment of a method for searching for a contact. Depending on the embodiment, additional blocks may be added, others removed, and the ordering of the blocks may be changed.

In block S401, the face database 22 is created. In one embodiment, the face database 22 stores face images, and associations of the face images with contact information.

In block S402, an image is selected from a photo stored in a memory system of the handheld device.

In block S403, the face recognition module 201 locates a face in the selected image. A detailed description refers to paragraphs are explained above.

In block S404, the face comparing module 202 compares the located face with the face images stored in the face database 22. In one embodiment, the face comparing module 202 compares the located face with the face images stored in the face database 22 by calculating a similarity between the located face and each face image stored in the face database 22.

In block S405, the determining module 203 determines if a matched face image is found in the face database 22, the process goes to block S406 if a matched face image is found, otherwise, the process goes to block S407 if no matched face image is found. To determine if a matched face image is found in the face database, the determining module 203 determines a face image in the face database 22 matches the located face if the similarity between the located face and the face image is greater than or equal to a preset value, and determines no matched face image is found in the face database 22 if the similarity between the located face and each face image stored in the face database 22 is less than the preset value.

In block S406, the displaying module 204 lists contact information associated with the matched face image. In one embodiment, the information includes a phone number of the contact.

In block S407, the face comparing module 202 creates an association between the located face and a user-selected contact, and stores the located face and the association in the face database 22.

In other embodiment, the method may further include locating all faces in the selected image if the selected image includes more than one face, and comparing each located face with the face images stored in the face database 22.

The present embodiments can locate a face in a selected image, find a face image matched to the located face from a face database 22, and list contact information associated with the matched face image, to facilitate the user to search a phone number of the contact and make a call.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for searching for a contact by a handheld device, the method comprising:
creating a face database, the face database storing face images, and associations of the face images with contact information of the contact;
selecting an image from a photo stored in a memory system of the handheld device;
locating a face in the selected image;
comparing the located face with the face images stored in the face database;
determining if a matched face image is found in the face database;
listing contact information associated with the matched face image if the matched face image is found in the face database, the information comprising a phone number of the contact; and
creating an association between the located face and a user-selected contact if no matched face image is found, and storing the located face and the association in the face database.

2. The method according to claim 1, further comprising:
locating all faces in the selected image if the selected image includes more than one face; and
comparing each located face with the face images stored in the face database.

3. The method according to claim 1, wherein the step of locating a face in the selected image comprises:
locating the face using a skin color model in YCbCr space; and
calculating a smallest rectangle framing the face to locate the face in the selected image.

4. The method according to claim 1, wherein comparing the located face with faces stored in the face database is achieved by calculating a similarity between the located face and each face image stored in the face database.

5. The method according to claim 4, wherein the step of determining if a matched face image is found in the face database comprises:
determining a face image in the face database matches the located face if the similarity between the located face and the face image is greater than or equal to a preset value; and
determining no matched face image is found in the face database if the similarity between the located face and each face image stored in the face database is less than the preset value.

6. A storage medium having stored thereon instructions that, when executed by a processor of a handheld device, causes the processor to perform a method for searching for a contact by the handheld device, the method comprising:
creating a face database, the face database storing face images, and associations of the face images with contact information of the contact;
selecting an image from a photo stored in a memory system of the handheld device;
locating a face in the selected image;
comparing the located face with the face images stored in the face database;
determining if a matched face image is found in the face database;
listing contact information associated with the matched face image if the matched face image is found in the face database, the information comprising a phone number of the contact; and
creating an association between the located face and a user-selected contact if no matched face image is found, and storing the located face and the association in the face database.

7. The storage medium according to claim 6, wherein the step of locating a face in the selected image comprises:
locating the face using a skin color model in YCbCr space; and
calculating a smallest rectangle framing the face to locate the face in the selected image.

8. The storage medium according to claim 6, wherein comparing the located face with faces stored in the face database is achieved by calculating a similarity between the located face and each face image stored in the face database.

9. The storage medium according to claim 8, wherein the step of determining if a matched face image is found in the face database comprises:
determining a face image in the face database matches the located face if the similarity between the located face and the face image is greater than or equal to a preset value; and
determining no matched face image is found in the face database if the similarity between the located face and each face image stored in the face database is less than the preset value.

10. The storage medium according to claim 6, wherein the medium is selected from the group consisting of a hard disk drive, a compact disc, a digital video disc, and a tape drive.

11. A contact search system for a handheld device, comprising:
a face database to store face images, and associations of the face images with contact information of the contact;
a face recognition module to locate a face in a selected image from a photo stored in a memory system of the handheld device;
a face comparing module to compare the located face with the face images stored in the face database;
a determining module to determine if a matched face image is found in the face database;
a displaying module to list contact information associated with the matched face image if the matched face image is found in the face database, the information comprising a phone number of the contact; and
the face comparing module further to create an association between the located face and a user-selected contact if no matched face image is found, and store the located face and the association in the face database.

12. The system according to claim 11, wherein:
the face recognition module is further to locate all faces in the selected image if the selected image includes more than one face; and
the face comparing module is further to compare each located face with the face images stored in the face database.

13. The system according to claim 11, wherein the face recognition module locates a face in the selected image comprises:
locating the face using a skin color model in YCbCr space; and
calculating a smallest rectangle framing the face to locate the face in the selected image.

14. The system according to claim 11, wherein the face comparing module compares the located face with faces stored in the face database by calculating a similarity between the located face and each face image stored in the face database.

15. The system according to claim 14, wherein the determining module determines if a matched face image is found in the face database comprises:
determining a face image in the face database matches the located face if the similarity between the located face and the face image is greater than or equal to a preset value; and
determining no matched face image is found in the face database if the similarity between the located face and each face image stored in the face database is less than the preset value.

16. The system according to claim 11, wherein the handheld device is selected from the group consisting of a cell phone, a digital camera, and a personal digital assistant (PDA).
